(19) United States
(12) Patent Application Publication
(10) Pub. No.: US 2024/0310231 A1
(43) Pub. Date: Sep. 19, 2024

(54) LEAK DETECTION APPARATUS AND METHOD

(71) Applicant: REDDEIGHT, INC., Menifee, CA (US)

(72) Inventors: Jose Solis, Menifee, CA (US); Michelle Hernandez-Kay, Menifee, CA (US)

(73) Assignee: REDDEIGHT, INC., Menifee, CA (US)

(21) Appl. No.: 18/415,520

(22) Filed: Jan. 17, 2024

Related U.S. Application Data
(60) Provisional application No. 63/439,542, filed on Jan. 17, 2023.

(51) Int. Cl. G01M 3/20

(52) U.S. Cl. CPC G01M 3/20

(57) ABSTRACT

A system for detecting leaks in a mechanical system includes a dye injector for injecting dye into the mechanical system, and a borescope having one or more tubes. Each tube includes a UV light source. The system further includes an image detector connected with at least one of the one or more tubes and configured to image a field-of-view of dye in the mechanical system being illuminated by the UV light source, the image detector including a light-filtering lens cap configured for filtering a first portion of UV rays from the UV light source to allow passage of a second portion of UV rays of the dye being illuminated by the UV light source.

### CROSS REFERENCE TO RELATED APPLICATIONS

The present application claims the benefit of U.S. Provisional Patent Application No. 63/439,542, filed Jan. 17, 2023, entitled “LEAK DETECTION APPARATUS AND METHOD,” the disclosure of which is incorporated herein by reference in its entirety.

### BACKGROUND

The present invention relates to a leak detection apparatus and system, and more particularly to an apparatus and system for rapidly detecting a dye that leaks from a mechanical system.

Almost all mechanical systems utilize some kind of fluid for their proper operation. For example, an evaporator is used in an automobile's air conditioning (AC) system and uses a refrigerant such as freon or other halocarbon gas. Or, an engine or other mechanical component may use a specialized lubricant that is needed to maintain the proper performance and functioning of that component.

Unfortunately, mechanical systems that use a fluid can often malfunction, such as crack, break, or the like, and are therefore prone to fluid leaks. In some cases, it is the fluid that might cause the malfunction or leak due to pressure or temperature issues. Typically, a service technician can detect a leak by visually observing a specially colored dye that is injected into a suspected malfunctioning component of a larger mechanical unit, such as the evaporator in an AC system. A dye is a colored substance, typically inert and non-functional, that bonds to a substrate, such as the freon in the evaporator in an AC system.

In the auto industry, for example, a dye is commonly placed in various parts of the automobile to determine if there is freon, oil or fuel leaks, each of these acting as a substrate for the dye, which can be specifically tailored for those substrates. In other industries, a dye may also be used as a mechanism to diagnose leaks in industries such as air, marine, sports, any mode of transportation and as well the in the residential industry for HVAC issues.

In the automobile example, when a customer has an AC concern or issue, it is common practice for a repair facility to determine if there is a freon leak. Freon is a liquid substance in a vehicle's AC unit that conditions the air to be cold and is used for the overall function of an air conditioner. Regarding AC leaks, dye is a liquid substance that is inserted into the AC fitting line and the freon therein specifically to enhance the ability to detect AC leaks. Dye has no impact on the freon's ability to keep the AC air cold. Commonly, vehicles dated approximately 2015 to date come with dye in the freon as a factory standard. This includes any type of vehicle that has AC, such as electric, hybrid, traditional, economical, sedans, fleet, diesel, commercial, etc. For models manufactured before 2015, technicians add dye into the AC fitting line as an extra step in the AC leak diagnosis process.

The dye is best detectable with the use of ultraviolet (UV) light, which in unfiltered form is harmful to the human eye. When UV light hits certain substances, such as dyes, they can fluoresce or glow brightly, and exhibit fluorescence. The fluorescence stimulated by UV light can include light at various spectra outside of the UV spectrum, such as blue or purple light. To view the fluoresced dye, a technician will wear safety glasses or goggles with particularly tinted lenses, such as yellow safety lenses, which are tailored to the UV-illuminated dye to make it easier to view the dye under UV illumination while filtering out other light sources, as well as provides a certain level of protection for the wearer, to confirm a leak.

Detecting leaks in a mechanical system, even one with a dye integrated with a fluid, is extremely laborious and time consuming. In one very common example, a traditional dye detection process for an AC system is as follows:
1) Recover freon from the evaporator. This checks to see if freon is low. The freon can be either freon R134a or R1234yf, or the like, each having slightly different qualities and characteristics, as well as flammability. Each type of freon also requires a different service fitting to the evaporator, to prevent cross-contamination of the freon with the associated vehicle system.
2) Recharge the freon. This refills the system to force a potential leak by pressurizing it.
3) Use UV flashlight and protective, wavelength-filtering eyewear to check for external leaks in the engine compartment. In this step, the technician actually gets under the vehicle to examine the undercarriage to examine for external AC system leaks. If no leaks are found externally, the next step is to diagnose a main internal part, the evaporator.

An evaporator diagnosis for an AC system freon leak is the most common diagnosis for an AC system malfunction. The evaporator diagnosis usually must follow the following steps:
1) Remove the vehicle's entire dashboard. This is an extremely time consuming and laborious process, which also presents risks of damage to the dashboard and other vehicle systems, such as the on-board computing and/or navigation system, central control systems, and even entertainment systems.
2) Open the evaporator case. This is also a very time-consuming step, which could risk damage to the case.
3) Use a UV-providing flashlight and protective and filtering eyewear to evaluate if the evaporator has dye present. If a leak is detected, repairs or corrections can be made to the evaporator at the detected site of a leak.
4) Reinstall the dashboard. Again, just as in removal of the dashboard to access the evaporator, reinstalling the dashboard is prone to error, mis-fittings, and damage to the dashboard and/or other systems in proximity.

To further explore the traditional model, the following is a more in-depth explanation of the process with a focus on the evaporator of an AC system:

An evaporator resembles a radiator and is enclosed in an evaporator case. In order to unveil the evaporator, the technician, in the traditional model, must open the evaporator case. In some instances, the evaporator case must be replaced regardless of an AC leak based on repair guidelines. Once the evaporator is exposed a technician may be able to visualize fluid on the evaporator; however, in most cases leaks are not visible by the naked eye. At times leaks are extremely small, similar to droplets or a “sparkle” and are best visualized with UV light to illuminate a dye mixed with freon in the evaporator.

The traditional model consists of using two primary tools. The first tool is yellow safety UV illuminating glasses worn by the technician, and the second tool is a UV flashlight controlled and operated by the technician, most often by hand. The technician first puts on the safety glasses to ensure their eyes are protected from any potential UV rays and their harmful effects. Then they direct the UV flashlight beam on one or more suspected leak areas in order to illuminate the dye in the freon in the event of a leak. The yellow lenses also assist with the reveal of the dye. Since most of the places that technicians need to detect leaks are in enclosed hard-to-reach places, such as the evaporator, significant time and money is used to accomplish a detection with no guarantee of a leak.

In most vehicles evaporators are found underneath the dash in an evaporator case. If the evaporator is not under the dash, it will be in another hard-to-reach, dark place in a cavity of a vehicle. For example, in large SUVs, the evaporator case is in the liftgate area in the cavity of the quarterpanel. Evaporators should not have any freon on their external area. When freon is present outside of the evaporator, dye is detectable and this substantiates a leak, confirming a case of AC dysfunction.

Whether or not a dash is needed to be removed and reinstalled, which is the most common requirement for detecting an AC system leak, detecting a freon leak in an evaporator is a tedious and lengthy task. A tenured, qualified technician can remove and install (“R&I”) a dash in 4 to 6 hours of labor. The standard estimated labor charge on this task is 8 hours. This means that an estimating software system will pay 8 hours of labor time for a technician to R&I a dash regardless of the actual time the takes to complete the task. While labor charges vary, current dealership labor rates for diagnoses are around $180 per hour. These costs are either passed to the customer, added as a dealership expense, or a vehicle's manufacturer may absorb the cost under a warranty.

Drilling holes in a fluid container such as an evaporator is not an uncommon practice. Technicians use this method to flush out the evaporator case to ensure it is clean. When complete, they plug the hole that was drilled with a secure tab. This secure tab method would be used if a hole was drilled during the dye detection process.

The task also requires much attention to detail to ensure that the integrity of the dash is intact at post-service delivery time. A technician must be certain no scratches, markings, or any other damages are created. Further, there are several small clips that hold the dash intact, and if even one of these clips is broken, this can result in the complete replacement of the dash. Dash prices can range from $500 to over $5000 depending on the type of vehicle and manufacturer.

At diagnosis time, it is unknown whether the evaporator is actually leaking, so the process of diagnosing an evaporator by removing the dash is done blindly and, in many instances, there may be no leak. This wastes time and money for all the vested parties.

What is needed is a leak detection apparatus and system, and a method of using the same, to detect fluid leaks in a mechanical system.

### SUMMARY

The present document describes a leak detection system and method, and dye detection apparatus used therewith, which vastly improves traditional techniques in terms of time and cost savings, and improved quality and integrity in a leak diagnosis process.

Consistent with the present disclosure, the dye detection apparatus includes a borescope with one or more flexible or semi-rigid or rigid tubes. The tubes include a UV light source, and an image detector to image a field-of-view illuminated by the UV light source. The image detector can detect and collect still images or video images. The image detector includes a light-filtering lens cap for filtering certain harmful UV rays and allowing passage of light waves of the dye illuminated by the UV light source, such as blue and violet light waves. In preferred implementations, the light-filtering cap on the image detector is yellow or a shade thereof.

In some implementations, the UV light source and the image detector can be formed in one common tube and residing at a distal end of the tube. In other implementations, the UV light source and image detector occupy separate but co-incident tubes. The tube or tubes can be articulating, where the distal end of the tube can articulate or be bent to one angle or a multitude of angles from a longitudinal axis of the tube.

In some implementations, the dye detection apparatus can further include a display for receiving and displaying an image or video images received by the image detector. The dye detection apparatus can also include one or more user-operable controls for controlling the UV light source and the image detector, and/or the tubes containing them. The user-operable controls can include controls to turn ON and OFF the UV light source and image detector, guide and/or position the tube(s) containing the UV light source and the image detector, and the like.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 depicts a dye detection apparatus in accordance with implementations of the currently described subject matter; and

FIG. 2 is a flowchart of a method for detecting a leak in a mechanical system using a dye detection apparatus as described herein.

Like reference symbols in the various drawings indicate like elements.

### DETAILED DESCRIPTION

This document describes a leak detection system and method. The system and method utilize a novel dye detection apparatus for detecting a leak of a fluid associated with the dye, which vastly improves traditional techniques in terms of time and cost savings, and improved quality and integrity in the leak diagnosis process. In the case of an automobile AC leak, for example, the dye detection apparatus can eliminate the unnecessary step of removing the dash to access the AC's evaporator for leak diagnosis and can therefore provide concrete evidence of a leak in minimal time.

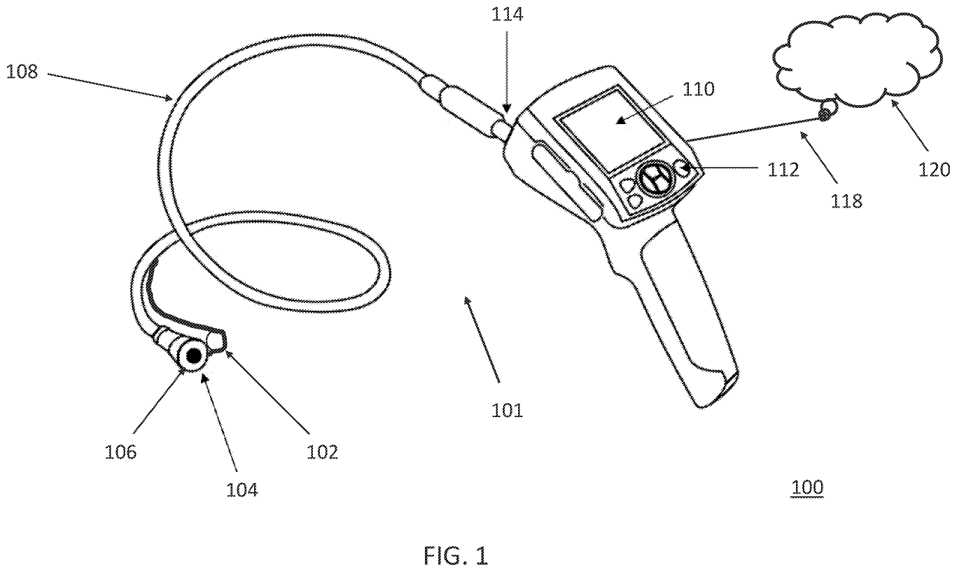

FIG. 1 depicts a dye detection apparatus 100 in accordance with implementations of the currently described subject matter. The dye detection apparatus 100 includes a borescope 101 with one or more flexible or semi-rigid or rigid tubes 108. The borescope 101 can be battery-powered, or can be plugged into an electrical source, such as an electrical outlet, via a wire.

The borescope 101 is an optical instrument designed to assist visual inspection of narrow, difficult-to-reach cavities, having a rigid or flexible tube 108 with an eyepiece or display on one end, an objective lens or camera on the other, linked together by an optical or electrical system in between. The optical system in some instances is accompanied by (typically fiberoptic) illumination to enhance brightness and contrast. An internal image of the illuminated object is formed by the objective lens and magnified by the eyepiece which presents it to the viewer's eye or a display. Borescopes are used for visual inspection work where the target area is inaccessible except by destructive, time consuming and/or expensive dismounting or deconstructive activities.

The tubes 108 include a UV light source 102, and an image detector 104 to image a field-of-view illuminated by the UV light source. The image detector 104 can detect and collect still images or video images. The image detector 104 includes a light-filtering lens cap 106 for filtering certain harmful UV rays and allowing passage of light waves of the dye illuminated by the UV light source 102, such as blue and violet light waves. In preferred implementations, the light-filtering cap 106 on the image detector 104 is yellow, or a shade of yellow. However, other colors/shades can be used, particularly depending on the light source and/or image detector and/or dyes used.

In some implementations, the UV light source 102 and the image detector 104 can be formed in one common tube 108 and reside at a distal end of the tube 108. In other implementations, the UV light source 102 and image detector 104 occupy separate but co-incident tubes 108. The tube or tubes 108 can be articulating, where the distal end of the tube 108 can articulate or be bent to one angle or a multitude of angles from a longitudinal axis of the tube 108.

The light filtering cap 106 can be a snap-on, screw-on, or friction-fit cap with a particularly colored lens. The lens can be circumscribed by a connecting frame. In some implementations, the light filtering cap 106, and/or its light filtering lens, can be removable and replaceable based on a type or hue of the dye. The cap is preferably round but can be any shape corresponding to the borescope. For instance, the cap can have a diameter of 3 to 8 mm. A screw-on cap can have a universal fit with threads that fit the most commonly used borescopes for each application.

In some implementations, the dye detection apparatus 100 can further include a display 110 for receiving and displaying an image or video images received by the image detector 104 through the lens cap 106. The dye detection apparatus 100 can also include one or more user-operable controls 112 for controlling the UV light source 102 and the image detector 104, and/or the tubes 108 containing them. The user-operable controls 112 can include controls to turn ON and OFF the UV light source 102 and image detector 104, guide and/or position the tube(s) containing the UV light source 102 and the image detector 104.

In some implementations, the borescope 101 can be a video borescope, such as an inspection camera or the like. The image detector 104 is a video detection device such as a video camera, which supplies a feed of video content to the display 110 in real time. The video feed can also be transmitted, wirelessly or otherwise, to a remote display, using a communication network 118. The communication network 118 can be a wireless network, such as Bluetooth, cellular, NFC, WiFi, or the like. The communication network 118 can include a transceiver (not shown) integrated with the display or as a separate module, to communicate the image data or diagnostic information to a remote device, such as a cloud computing device, remote server, remote computing device, mobile computing device, or the like.

The display 110 of the dye detection apparatus 100 can also feature one or more applications, which can be tailored to manipulate or enhance images detected by the image detector 104. For instance, a video display application can sense when a leak is detected, and automatically initiate some action, such as sending the video to a remote device, assessing the extent or severity of the leak, or provide a number of other recordable metrics that can be used, inter alia, with warranty contracts or service commitments by vehicle maintenance companies or vehicle sellers.

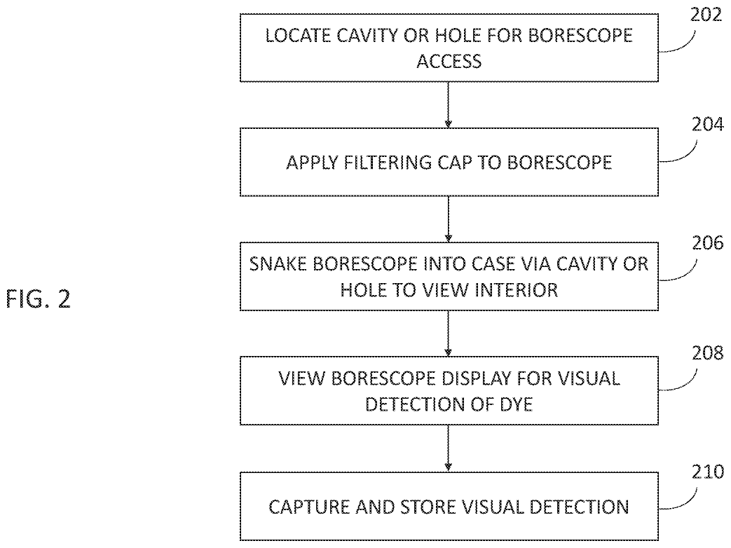

In accordance with implementations described herein, and as shown in FIG. 2, a method 200 of detecting a leak using a dye-fluorescing borescope includes the following steps. While the method 200 is described in the context of detecting a leak in an evaporator of an automobile's air conditioning (AC), those having skill in the art would recognize that the steps could be applied in other settings or mechanical systems as well. At 202, a cavity of the evaporator case that will give access to the evaporator using the borescope is located. If one cannot be found or located, a hole can be drilled near the evaporator to gain access.

At 204, a light filtering cap is applied onto the borescope. As described above, the light filtering cap on the image detector is preferably yellow, or a shade of yellow, but can be other colors or shades depending on the light source and/or image detector and/or dyes used. At 206, the borescope is snaked into the evaporator case (or other mechanical system) via the cavity or hole to view the interior of the evaporator. At 208, a display of the borescope can be viewed to look for visual signs of a dye that has been inserted into the evaporator, the visual signs being highlighted by a light wave filter of the light filtering cap. Any visual signs of the dye will instantly indicate a leak. Finally, at 210, images of any detected leak can be captured from the display and stored in a memory, for accessing or sharing later.

In most cases, the method 200 takes 5 to 30 minutes, which is far less time than conventional methods. In the context of detecting a leak in an evaporator of an automobile's air conditioning (AC), below is more information about the process and the benefits of the present invention.

The evaporator case is commonly under the dash and part of the case is visible and accessible from the bottom of dash on the inside of a car. Some evaporator cases may have a crevice large enough to snake the dye detector through to visualize the evaporator, making the diagnosis process incredibly easy. If there is not direct access to the evaporator a technician can drill a hole in the evaporator to gain access to the evaporator.

The dye detector can be purchased as a cap only so that technicians can use their borescope of choice, or it can be purchased as a kit that includes a borescope. In some implementations, a kit can include Bluetooth capability, or be shrink wrapped for wired versions with the dye detector cap.

The cap is projected to have a universal fit to fit most borescopes ranging in size between 3 mm to 8.5 mm. The cap has a halo ring with UV light. In the center of the ring is the yellow cap. The UV light must have a power source, the initial version will have a wired power source and future versions can be wireless with charging capability. A technician will run the wire along the borescope and then shrink wrap it along the borescope to secure it during diagnosis. Shrink wrap can be easily removed after use.

Using the dye detection apparatus and leak detection system and method as described herein has many benefits and improvements over conventional systems and methods, such as, for example, warranty efficiency and fraud prevention: The dye detector will also create efficiencies in warranty claims and to prevent fraud. AC leaks that are covered under warranty are subject to a certain amount of service time. Vehicle maker warranty companies rely on the integrity of the technicians and the dealership to confirm warranty-covered claims. Warranty approvals are moving towards a more viable verification process including submission of photos along with the written stories currently submitted by technicians. The dye detector will have the components necessary to allow technicians to take instant photos that can be used as potential warranty proof

Although a few embodiments have been described in detail above, other modifications are possible. Other embodiments may be within the scope of the following claims.

1. A system for detecting leaks in a mechanical system, the system comprising:
a dye injector for injecting dye into the mechanical system;
a borescope having one or more tubes, each tube including a UV light source; and
an image detector connected with at least one of the one or more tubes and configured to image a field-of-view of dye in the mechanical system being illuminated by the UV light source, the image detector including a light-filtering lens cap configured for filtering a first portion of UV rays from the UV light source to allow passage of a second portion of UV rays of the dye being illuminated by the UV light source.

2. The system in accordance with claim 1, wherein the light-filtering lens cap of the image detector is a shade of yellow.

3. The system in accordance with claim 1, wherein at least one of the one or more tubes is flexible.

4. The system in accordance with claim 1, wherein at least one of the one or more tubes is rigid.

5. The system in accordance with claim 1, wherein the image detector is configured to detect and collect still images and/or video images.

6. The system in accordance with claim 1, wherein the second portion of UV rays is a shade of blue or violet waves.

7. The system in accordance with claim 1, wherein the image detector is connected at a distal end of the at least one of the one or more tubes and coincident with the UV light source.

8. The system in accordance with claim 1, further comprising a display configured to receive and display image or video received by the image detector through the light-filtering lens cap.

9. The system in accordance with claim 1, further comprising one or more user-operable controls for controlling the UV light source, the image detector, and/or the one or more tubes.

10. A system for detecting leaks in a mechanical system, the system comprising:
a dye injector for injecting dye into the mechanical system;
a borescope having one or more tubes, each tube including a UV light source;
an image detector connected with at least one of the one or more tubes and configured to image a field-of-view of dye in the mechanical system being illuminated by the UV light source, the image detector including a light-filtering lens cap configured for filtering a first portion of UV rays from the UV light source to allow passage of a second portion of UV rays of the dye being illuminated by the UV light source; and
a display in communication with the image detector and configured to receive and display image or video received by the image detector through the light-filtering lens cap.

11. The system in accordance with claim 10, wherein the display is in communication with the image detector via a wired connection.

12. The system in accordance with claim 10, wherein the display is in communication with the image detector via a wireless connection.
